(19) United States
(12) Patent Application Publication
(10) Pub. No.: US 2024/0426551 A1
(43) Pub. Date: Dec. 26, 2024

(54) AN EFFICIENT HEAT PUMP-BASED HEATING SYSTEM WITH HEAT RECOVERY

(71) Applicant: GEA Process Engineering A/S, Søborg (DK)

(72) Inventors: Lorenzo Bellemo, Søborg (DK); Riccardo Bergamini, Søborg (DK)

(73) Assignee: GEA Process Engineering A/S, Søborg (DK)

(21) Appl. No.: 18/708,266

(22) PCT Filed: Nov. 12, 2021
(86) PCT No.: PCT/DK2021/050332

§ 371 Date: May 8, 2024

(51) Int. Cl. F26B 23/00; F26B 21/06

(52) U.S. Cl. CPC F26B 23/005; F26B 21/06

(57) ABSTRACT

The invention relates to a heating system comprising a heat pump system. The heat pump system comprises a heat pump, operating with a primary fluid, and a secondary fluid. The heat pump system further comprises a first sink heater. The heat pump is connected to the first sink heater, and the first sink heater is configured to preheat a process medium. The heating system further comprises a second sink heater configured to transfer heat to a second process medium. The heat pump system further comprises a heat exchanger that is connected to the second sink heater and is configured to transfer heat from an exhaust medium of the second sink heater to the secondary fluid used to provide heating to the process medium. The heat pump is connected to the heat exchanger in a parallel configuration. Furthermore, a method for integrating a heating system into a drying plant, the heating system comprising a heat pump system, is provided.

### TECHNICAL FIELD

The present invention relates to a heating system comprising a heat pump system, the heat pump system comprising a heat pump operating with a primary fluid, a secondary fluid and a first sink heater, the heat pump being connected to the first sink heater, wherein the first sink heater is configured to preheat a process medium, the heating system further comprising a second sink heater, wherein the second sink heater is configured to transfer heat to a second process medium, the heat pump system further comprising a heat exchanger being connected to the second sink heater and being configured to transfer heat from an exhaust medium of the second sink heater to the secondary fluid used to provide heating to the process medium.

The invention furthermore relates to a method for integrating a heating system into a drying plant, the heating system comprising a heat pump system.

### BACKGROUND ART

Spray drying plants are usually quite large energy intensive installations with a high specific thermal energy demand on a high temperature level of above for example 200° C., which is therefore mostly provided by a primary energy combustion process with high greenhouse gas emissions. The combustion process provides heating energy to a process gas or process medium—usually ambient air—at a temperature as high as needed for the entry into the drying process, usually between about 170° C. and 240° C., sometimes even higher. The process gas provides the energy to evaporate the solventmost commonly water—during the drying process and leaves the process as warm and humid exhaust gas on a low temperature level, usually between 65-90° C. This low temperature level of the dryer exhaust gas would only allow a limited heat recovery by heat transfer into the drying process gas, usually within 20% (depending on the plant configuration) of the heating energy needed. Therefore, over 80% of the heating energy is subsequently lost with the dryer exhaust gas, particularly in the form of latent heat. Therefore, the specific energy demand related to output of dried product is not reduced significantly.

Spray drying plants may comprise devices for air handling for all air streams needed for the process (i.e. air heaters, supply fans, dehumidifiers, coolers, and systems for exhaust air cleaning etc., which equipment in the present context is designated the air handling unit), product handling (i.e. feed pump, atomizer etc.), air disperser, drying chamber, heat recovery, and powder recovery. All systems can be provided with pre- and post-treatment equipment, for example evaporators, homogenizers, fluid bed dryer/cooler, agglomerator, de-duster and conveyor etc., so that the plant meets individual product specifications, operational safety, and environmental protection requirements. Also, the plants are available in open, closed, semi-closed and aseptic cycle versions.

The use of a heat pump for heat transfer from dryer exhaust gas for the single task of pre-heating a process gas in a spray-drying facility is a wellknown concept. In WO 2018/091049 A1, a drying system comprising a drying plant and a heat pump assembly is disclosed.

CO₂ heat pumps can be used to obtain high temperatures up to 150° C., with ongoing developments to increase this maximum temperature. In such heat pumps, the refrigerant (carbon dioxide) releases heat in the supercritical phase, i.e. it is cooled at nearly constant pressure without condensing.

At the same time, CO₂ heat pumps can be used to supply cold water at low temperatures (approaching 0° C. when cooling pure water). CO₂ heat pumps can therefore provide high temperature heating and low temperature cooling with single-stage compression.

However, when a high temperature heat pump (here intended as any heat pump type that can warm up the process gas above approx. 70° C.) is integrated into a drying plant to preheat the main air stream before a successive heating step with a conventional heater, a problem that is faced is a reduced efficiency of said heater, especially in cases it is a steam or indirect gas heater. That can also apply to other drying process airstreams, where a high temperature heat pump is integrated before a final heating step carried out with a steam or indirect gas heater. With preheating from a high temperature heat pump system, the main air entering the main heater can exceed 100° C., which leads to a reduced heat recovery potential from the main heater exhaust stream or exhaust medium, i.e. hot condensate or hot water for steam heaters or flue gas for indirect gas heaters. In fact, it is common practice to recover heat from hot condensate from a steam heater in a condensate cooling section placed in the airstream in front of the steam heater, or from the flue gas out of the indirect gas heater either in an air-flue gas heat exchanger or via a secondary circuit extracting heat from the flue gas for heating process air before the indirect gas heater.

For steam heaters, in addition to the reduced main heater efficiency problem, another problem is the temperature of condensate returned to the steam boiler. That condensate is normally returned to the boiler at temperatures between 80° C. and 95° C. Different temperatures can though be accepted, depending on the steam boiler system operation. With process air entering the steam heater above 100° C., condensate would return to the boiler warmer than 100° C., which would have two major detrimental effects: (1) affect the operation of the steam boiler system with consequent reduction of energy efficiency, and (2) require a redesign of the condensate return line to accommodate for higher condensate return temperatures.

### SUMMARY OF THE INVENTION

The present invention relates to a heating system comprising a heat pump system for increasing the energy efficiency of the whole heating system (heat pump and conventional heaters) in an economical way.

In a first aspect of the invention, this and further objects are achieved with a heat pump system of the kind mentioned in the introduction, which is furthermore characterized in that the heat pump is connected to the heat exchanger in a parallel configuration.

In a preferred embodiment of the invention, the heat pump is connected to the first sink heater via a secondary fluid or secondary medium, wherein the first sink heater is configured to preheat a process medium, the heating system further comprising a second sink heater, wherein the second sink heater is configured to transfer heat to a second process medium, the heat pump system further comprising a heat exchanger being connected to the second sink heater via an exhaust medium and being configured to transfer heat from an exhaust medium of the second sink heater to the secondary fluid used to provide heating to the process medium.

In an embodiment, the first sink heater is connected in series with the second sink heater and the process medium is an air stream flowing into the second sink heater. The second process medium is therefore the same with the process medium flowing directly into the second sink heater.

In alternative embodiment, the second sink heater is not connected in series with the first sink heater but is placed on a different air stream. The second process medium is therefore flowing into the second sink heater, which generates the exhaust medium, while the process medium of the first sink heater flows into the dryer.

Even in the case of integration of a heat pump into a second process stream or medium than the one heated by a conventional heater, the efficiency of said heating system may be increased by recovering heat from the exhaust stream of the conventional heater in the heat exchanger placed in parallel to the heat pump for the goal of heating the second process stream. Also in this case, there may be an economic benefit derived by a decreased size of the heat pump.

The components mentioned above and further below may not be physically connected, but there is a connection allowing a process medium to flow into a first component and then to a second component etc.

The recovery of heat from the exhaust medium of the second sink heater via the heat exchanger (or economizer) placed in parallel to the heat pump may be an economic and effective way to recover energy. In this way, part of the flow of the secondary fluid in the first sink heater is heated by the heat exchanger and part of it is heated by the heat pump. The temperature of the secondary fluid heat medium, which may be water, can reach high temperatures up to 130° C. and above, depending on the limit given by the heat pump used.

In addition to high-temperature systems, non-high temperature systems, for example heating air up to 80° C., may also benefit from the parallel connection of the heat exchanger and the heat pump. The temperature of the secondary fluid that is produced in the heating system may range from 90° C. to 130° C. but is not limited to that range. The secondary fluid may consist or comprise water, or other substances. The exhaust medium from the heater May comprise hot/warm water or flue gas.

Furthermore, significant cost savings may arise from the present invention, since a heat pump of a smaller size will be required due to the heat recovery in the heat exchanger, thus leading to lower system costs. Moreover, the system may result in an overall lower electricity consumption.

The heat pump system or heat pump assembly may comprise one or more heat pumps.

The first sink heater may be the preheater connected to the heat pump system. The first sink heater may constitute a first heat sink heat exchanger. The second sink heater may be the process air heater (e.g. steam heater or indirect gas heater) or a second heat sink heat exchanger. The second sink heater is heating the process air, which is comprised or consisted in the sink. For the process air heater or second sink heater, the heat source may be the steam or gas entering into it.

In an embodiment, the heat pump operates with a primary fluid and a secondary fluid, the primary fluid being an operating medium in a transcritical cycle, preferably comprising R744. In the transcritical cycle, R744 is found in supercritical phase when releasing heat to produce hot water and in two-phase (subcritical) phase when absorbing heat from one or multiple heat sources, e.g. cold water. The primary fluid is not limited to the afore-mentioned refrigerant and may comprise other refrigerants. In addition, refrigerants operating in other types of cycles may be included, such as reversed Brayton, subcritical, transcritical, cascade, absorption and/or hybrid absorption/compression cycles.

The process medium may be an air stream.

The heat exchanger may be a plate heat exchanger or a fin-and-tube heat exchanger. Alternatively, the heat exchanger may be of a shell and tube, dimple plate, or tube in tube type.

The economizer used in the system may be a heat exchanger used for warming up water (generally a liquid, as it could potentially be other than pure water) by cooling another stream, which depends on the type of heater generating it. The economizer may be a plate heat exchanger, in case of a steam heater that exhausts hot condensate or a fin-and-tube heat exchanger, in case of indirect gas heater that exhausts hot flue gas, with water running inside the tubes and flue gas outside in contact with the fins. Other types of heat exchangers may also be employed as mentioned above.

In an embodiment, the heating system is installed in a drying plant.

In another embodiment, the drying plant comprises a spray drying apparatus.

The list of products which may be spray dried is extensive and include among other ingredients for dairy, food, chemical, agro-chemical, energy, biotechnology, pharmaceutical, semi-pharmaceutical, healthcare, food additives, food ingredients, microorganisms, proteins, peptides, whey, and many more, and are not limited in application to the examples given but are wide open for all such products. Suitable products are defined by their drying characteristics and not by their use or origin.

In an embodiment, the second sink heater is arranged after the first sink heater in the flow direction of the process medium and the second sink heater may generate the exhaust medium.

The heat exchanger may be configured to recover only sensible or sensible and latent heat from the exhaust medium leaving the second sink heater.

In an embodiment, the heat pump system further comprises a control device for controlling by flow, pressure and/or temperature the connection of the heat exchanger with the first sink heater and the heat pump.

The heat exchanger may comprise an inlet and an outlet, and the control device may be a flow regulation device installed between the heat pump and the first sink heater, the heat pump system further comprising a first temperature sensor positioned at the outlet of the heat exchanger.

The control device may be configured to operate such that the temperature of the first temperature sensor is in accordance with a predefined temperature setpoint.

The control device may be a constant flow rate valve, such as a 3-way valve.

In an embodiment, the heat pump system further comprises a temperature transmitter connected with the first temperature sensor.

In an embodiment, the heat pump comprises an inlet and an outlet, the heat pump system further comprising a second temperature sensor positioned at the outlet of the heat pump, wherein the control device is configured to operate such that a temperature of the first temperature sensor is in accordance with a temperature at the second temperature sensor. The temperature of the first temperature sensor may be equal, proportional or generally dependent on a temperature at the second temperature sensor.

The heat exchanger line may be controlled in different ways, resulting in different splits of water (or other fluids) between the heat exchanger and the heat pump.

The first sink heater may constitute a preheater for drying air to the spray drying apparatus, wherein the second sink heater may constitute a process air heater for drying air to the spray drying apparatus, and wherein the heat exchanger may constitute an economizer having an inlet connected to the outlet of the process air heater and an outlet configured to be connected to the inlet of the preheater.

In an embodiment, the process medium constitutes an air stream, wherein the secondary fluid constitutes water and wherein the primary fluid of the heat pump comprises carbon dioxide.

In another embodiment, the heat pump system further comprises a circulation pump connected with the first sink heater and the heat pump.

In an alternative embodiment, the heat pump is further connected to one or multiple heat sources, the heat source being connected to the heat pump via an ice water or cold water circuit or directly without any intermediate circuit. The ice or cold or chilled water circuit may comprise water at temperatures of 1° C. to 20° C. In cases of water and glycol mixtures, sub-zero temperatures may even be reached (e.g. −10° C.). The heat source may be any process stream cooled by the ice/cold water circuit, dryer exhaust air, dryer intake air, vapor out of the evaporators or condensate out of evaporator condenser.

The heat pump may be used to cool the ice water providing cooling to one or more processes in the plant, which require cooling.

Alternatively, heat may be extracted from the dryer exhaust air, with or without condensation of the moisture in the exhaust air stream.

In another embodiment, process air may be dehumidified by means of the cold water produced by the heat pump for e.g. increasing the dryer productivity, improving powder quality, etc.

In another embodiment, cooling for condensing the vapor generated in the product evaporation stages may be provided by the heat pump.

In another embodiment, cooling for reducing the temperature of the condensate out of the condenser used for the evaporators may be provided by the heat pump.

The heat pump system may comprise a fluid network and control devices, wherein the heat pump may be connected to the fluid network, wherein the control devices may control the flow, flow direction, pressure and temperature of parts of the fluid network.

According to a second aspect of the invention, a method for integrating a heating system into a drying plant is provided, the heating system comprising a heat pump system, the heat pump system comprising a heat pump operating with a primary fluid, a first sink heater and a heat exchanger, the method comprising the steps of
connecting the heat pump with the first sink heater, wherein the first sink heater is configured to preheat a process medium,
the process medium entering a second sink heater,
connecting the second sink heater to the first sink heater, the second sink heater being configured to transfer heat to the process medium,
connecting the heat exchanger to the second sink heater such that the heat exchanger can transfer heat from an exhaust medium to a secondary fluid,
connecting the heat pump to the heat exchanger in a parallel configuration, and
controlling by flow, pressure and/or temperature the connection of the heat exchanger to the heat pump with a control device.

In another embodiment, a method for integrating a heating system into a drying plant is provided, wherein the drying plant comprises a spray drying apparatus and wherein the first sink heater constitutes a preheater for drying air to the spray drying apparatus, wherein the second sink heater constitutes a process air heater for drying air to the spray drying apparatus, and wherein the heat exchanger constitutes an economizer having an inlet connected to the outlet of the process air heater and an outlet configured to be connected to the inlet of the preheater.

### BRIEF DESCRIPTION OF DRAWINGS

In the following description, embodiments of the invention will be described with reference to the schematic drawings, in which:

FIG. 1 shows a schematic view of a heating system in an embodiment of the present invention;

FIG. 2 shows a schematic view of a heating system in another embodiment of the invention wherein the heating system is installed in a drying plant; and

FIG. 3 shows a schematic view of a heating system in yet another embodiment of the invention installed in a drying plant;

FIG. 4 shows a schematic view of a heating system in another embodiment of the invention showing the control configuration;

FIG. 5 shows a schematic view of a heating system in yet another embodiment of the invention showing the control configuration; and

FIG. 6 shows a schematic view of a heating system in an alternative embodiment.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided for thoroughness and completeness.

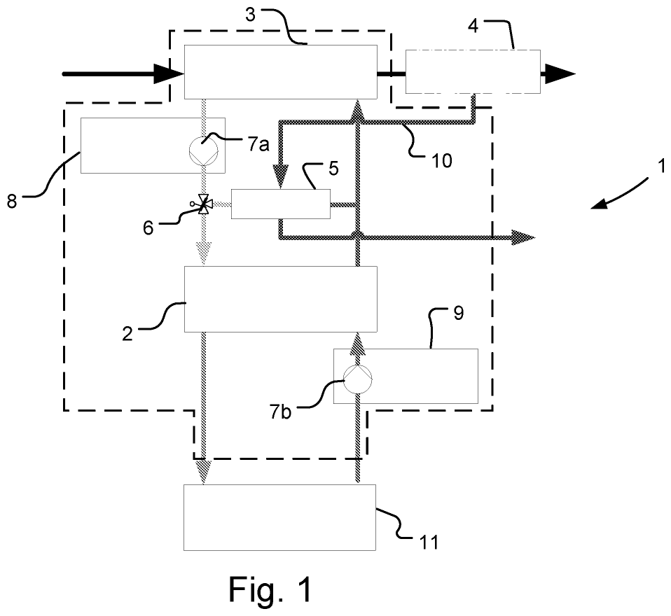

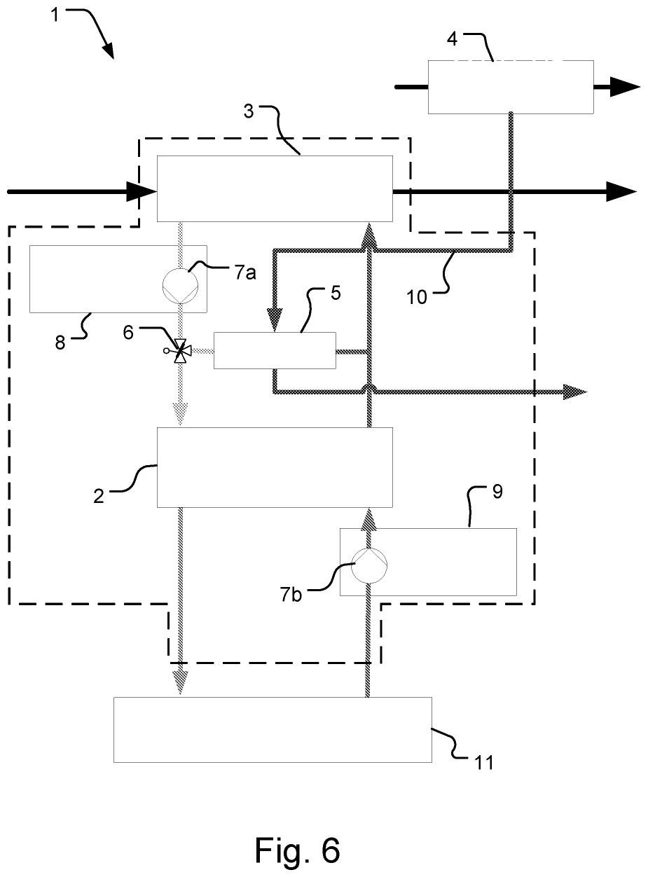

FIG. 1 shows a schematic view of the main components of a heating system 1 comprising a heat pump system. The heat pump system comprises a heat pump 2 operating with a primary fluid and a first sink heater 3. In this case, the primary fluid of the heat pump 2 comprises carbon dioxide. The heat pump 2 is connected to the first sink heater 3. The first sink heater 3 is configured to preheat a process medium, which in this embodiment is gas or air. The heating system 1 further comprises a second sink heater 4, which is connected to the first sink heater 3 and is configured to transfer heat to the process medium. The heat pump system further comprises a heat exchanger 5 that is connected to the second sink heater 4 and is configured to transfer heat from an exhaust medium, which is hot condensate, pressurized water or flue gas, of the second sink heater to a secondary fluid, which in this case is water. The second sink heater 4 is configured to transfer heat to a second process medium. In the embodiment shown in FIG. 1, the second process medium is the same as the above-mentioned process medium comprising gas or air, i.e. the second sink heater 4 is here used to provide heating to the same stream or flow of process medium as the first sink heater 3. As an alternative, the second process medium is different from the process medium processed in the first sink heater 3, confer the embodiment of FIG. 6 to be described in detail below. The heat pump 2 is connected to the heat exchanger 5 in a parallel connection.

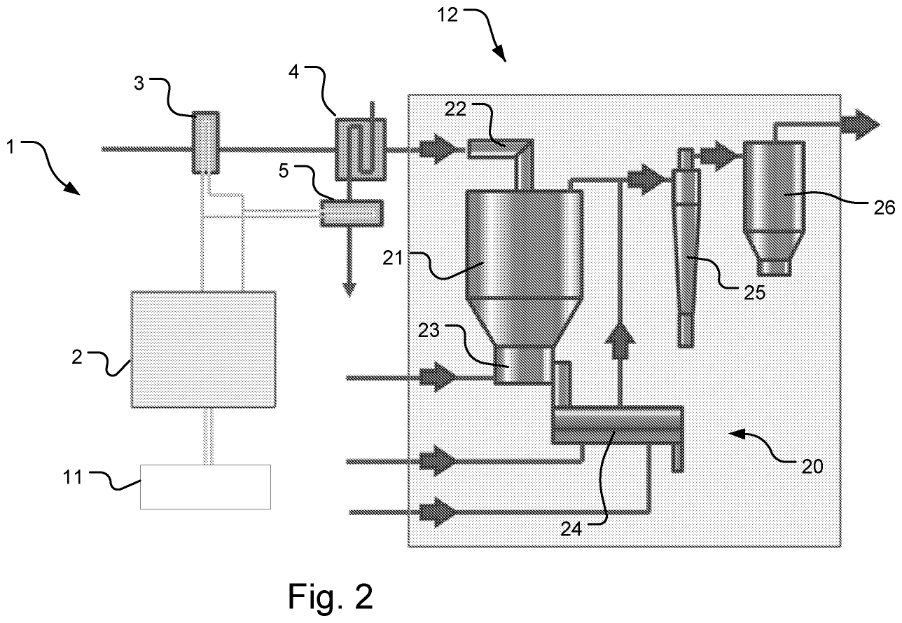

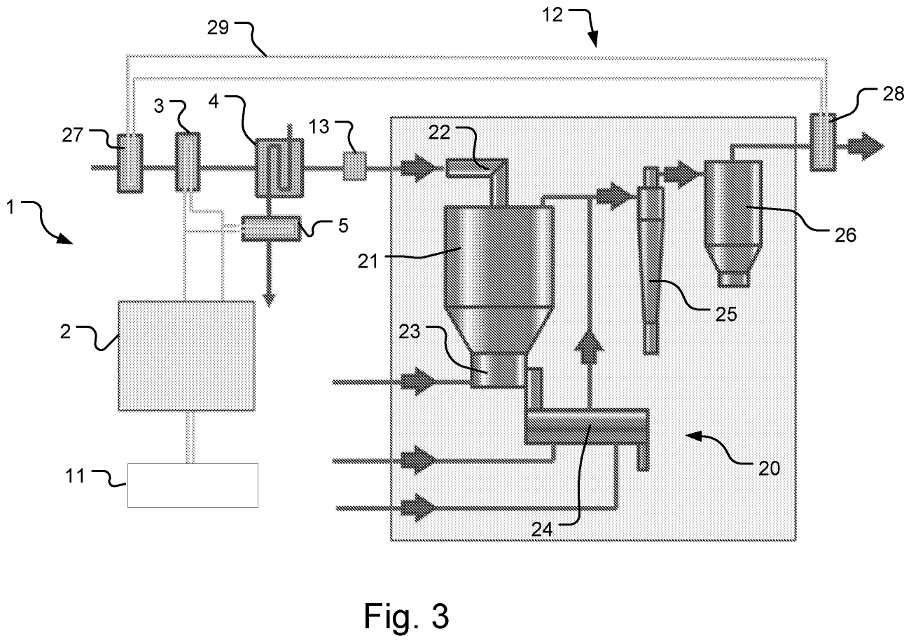

In the embodiment shown here, the second sink heater 4 is arranged after the first sink heater 3 in the flow direction of the process medium and the second sink heater 4 generates the exhaust medium. The first sink heater 3 constitutes a preheater for drying air to the spray drying apparatus 20 (shown in FIGS. 2-3), and the second sink heater 4 constitutes a process air heater for drying air to the spray drying apparatus 20. The air stream exiting the second sink heater 4 enters the dryer, as shown in FIG. 2.

The heat exchanger 5 is configured to recover only sensible or sensible and latent heat from the exhaust medium leaving the second sink heater 4. The heat exchanger 5 comprises an inlet and an outlet. The heat exchanger 5 constitutes an economizer having an inlet connected to the outlet of the process air heater 4 and an outlet configured to be connected to the inlet of the preheater 3.

The heat pump system comprises a control device, in this case a 3-way valve 6, for controlling by flow, pressure and/or temperature the connection of the heat exchanger 5 with the first sink heater 3 and the heat pump 2. The control device 6 is a flow regulation device installed between the heat pump 2 and the first sink heater 3.

Moreover, the heat pump system further comprises a hot water pump 7a connected with the first sink heater 3 and the heat pump 2. A cold water pump 7b is also comprised between the heat pump 2 and the heat source 11. The heat source 11 is connected to the heat pump via an ice or cold water circuit.

Alternatively or additionally, a hot water pump skid 8 and a cold water pump skid 9 are included in the heating system to circulate water.

In the embodiments shown in FIGS. 2 and 3, the heating system 1 is installed in a drying plant 12. The drying plant 12 is a multi-stage MSD® Spray Dryer, which combines spray and fluid bed drying technology to a three stage drying process to ensure the best overall drying efficiency and product quality. However, any other type of dryer is suitable for being integrated with the system.

The spray drying apparatus 20 comprises a drying chamber 21 and a primary inlet 22 for process air/gas including an air/gas disperser. It is noted that the term “gas” will be used alongside with the term “air” as “air/gas” and is to be interpreted as encompassing any gas that is suitable as process gas in such a spray drying apparatus.

The drying chamber 21 also incorporates atomizing means (not shown), such as nozzles and/or an atomizer wheel. The term “drying plant” is intended to encompass such plants in which a powdery or particulate material is processed. The material may either be provided as a feed of powdery or particulate material, or as a liquid feed to be dried. The drying plant 12 is also intended to cover cooling of the particulate material. In addition to or alternatively to the spray drying apparatus described, such a plant could include one or more fluid beds, flash dryers etc.

At the lower end of the drying chamber 21, an outlet 23 for dried or semi-dry intermediate material is provided. In the shown spray drying apparatus 20, an after-treatment unit in the form of vibrating or static fluid bed 24 is provided. At one end, the vibrating or static fluid bed 24 receives dried or semi-dried material from the outlet 23 of the drying chamber 21 for further treatment of the material, which is then to be collected at an outlet at the other end of the vibrating or static fluid bed 24.

Furthermore, the spray drying apparatus 20 comprises a series of powder recovery units including a number of filter units, cyclones and/or bag filters, or any combination thereof. In the systems of FIGS. 2 and 3, one cyclone 25 is shown, to which spent process gas with particles entrained in the process gas is conducted. The process gas conducted to the cyclone 25 can as shown originate from the drying chamber 21 or the vibrating or static fluid bed 24. The cyclone 25 is connected to a bag filter 26, both with the purpose to recover or collect particles from the spent process gas (not shown), from which exhaust gas is discharged, either to the surroundings or to be recycled, for instance in the case of a closed cycle system in which the exhaust gas leaving the spray drying apparatus 20 is reused as process gas.

In FIG. 3, a number of heat sink heaters may be utilized, namely for pre-heating of the primary process gas inlet 22 for drying gas to the drying chamber 21 by means of heat exchangers 3, 27; as heaters of a side stream for secondary process gas inlet at the outlet 23 from the drying chamber 21 for transportation of dried or semi-dried material by means of another heat exchanger (not shown); and for heating of side streams to a respective end of the fluidizer 24 in a tertiary and quaternary gas inlet by means of other heat exchangers (not shown).

The exhaust gas leaving the drying plant 12 is recovered as a heat source by means of the heat exchanger 28, which is connected back to heat exchanger 27. A piping 29 is included as part of the fluid network of the overall system.

For example, in a dryer exhaust heat recovery unit 28, a heat exchanger acting as a preheater 27 would be required.

The heating system 1 also comprises an electric heater or booster 13 installed after the second sink heater 4 to help reach higher temperatures in the case of a steam heater.

A number of conveying lines connect the operational units with each other in a manner known per se and will not be described in detail.

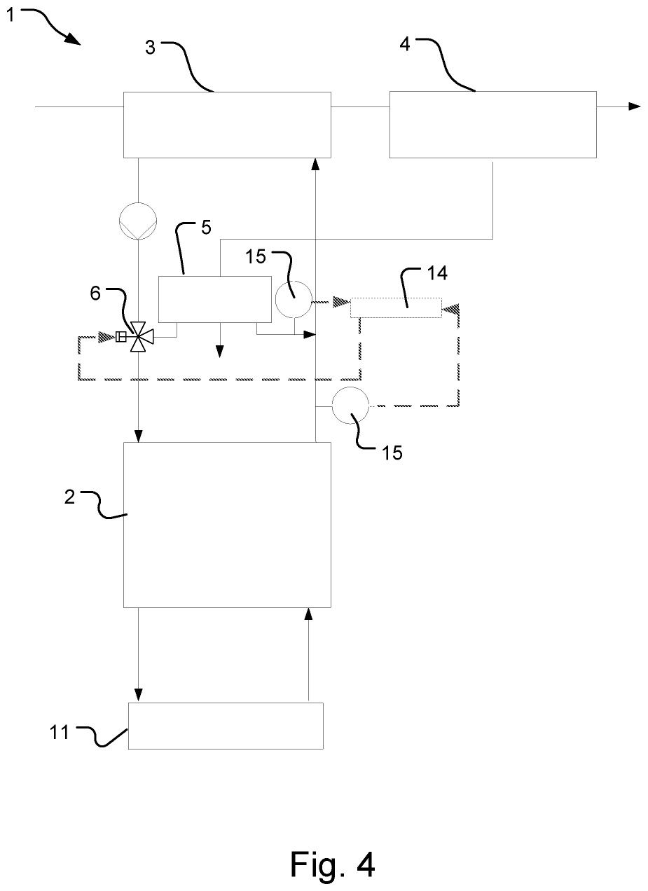

In FIG. 4, the heat pump system further comprises two temperature sensors 15, one positioned at the outlet of the heat exchanger 5 and one positioned at the outlet of the heat pump 2, respectively. A control device or 3-way valve 6 is positioned at the split point between the return line from the preheater 3 and the economizer 5 and heat pump 2 lines. In this way, the 3-way valve 6 is used to regulate the split of water flow between the heat exchanger or economizer 5 and the heat pump 2. The dashed lines in FIG. 4 indicate that the 3-way valve 6 is controlled to have the economizer 5 producing hot water at the same temperature (process value to the controller 14) as the hot water produced by the heat pump 2 (setpoint to the controller 14). This is achieved by the controller 14 sending a control signal back to the 3-way valve 6. In this embodiment, a constant water flow is maintained at the preheater 3, while the heat pump 2 is controlled to produce cold water at a specified setpoint. Therefore, the 3-way valve 6 is configured to operate such that a temperature of the first temperature sensor is in accordance with a predefined temperature setpoint. A temperature transmitter (not shown) is connected with the temperature sensor 15.

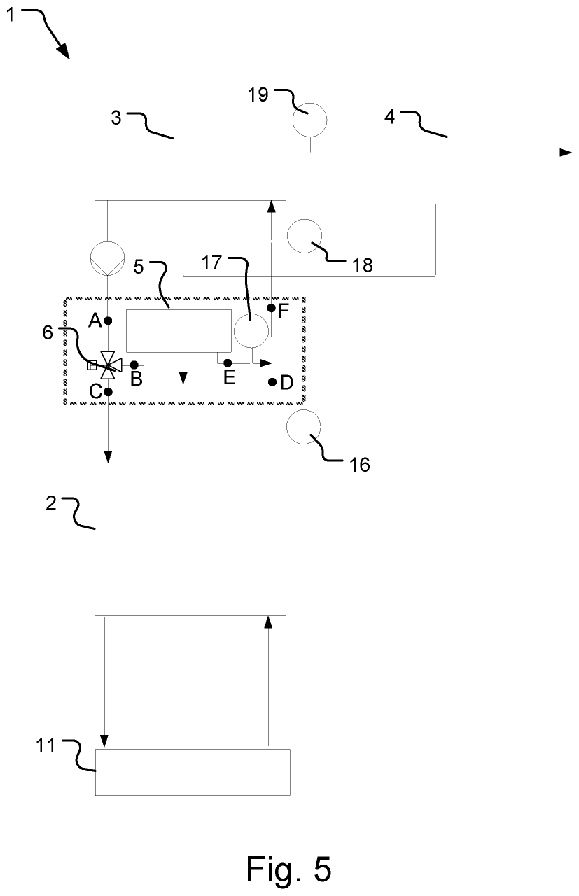

As shown in FIGS. 4-5, the heat pump system comprises a fluid network and control devices. The heat pump 2 is connected to the fluid network, and the control devices can therefore control the flow, flow direction, pressure and temperature of parts of the fluid network.

In FIG. 5, the control device or valve 6 is configured to operate such that a temperature of the first temperature sensor 16 is in accordance with a temperature at the second temperature sensor 17. A temperature transmitter may be associated with each temperature sensor. Points A and D are inlets to the solution, whose conditions (temperature and flow) can be constant or varying depending on the control logics chosen for the water pump and heat pump 2. The control of water pump and heat pump is not described further as it not a specific feature of the solution. However, different water pump and heat pump control logics could influence the selection of a specific control logic for the economizer 5 branch.

The economizer line is controlled via a 3-way valve placed at the split point between the return line from the preheater 3 and the economizer 5 and heat pump 2 lines. Alternatively, 2-way valves can be used, either on the economizer 5 or heat pump 2 branch, resulting in analogous control logics. The choice between 2- or 3-way valves depends on controllability and economical considerations.

The 3-way valve 6 can be operated with the goal of:
1) making the second temperature transmitter 17 reach the same value as the first temperature transmitter 16, and/or
2) making the second temperature transmitter 17 reach a predefined or specified setpoint (constant or varying by means of optimizers, predictive models, etc.), and/or
3) operating with constant water flow rate at the economizer 5 line, and/or
4) operating with constant water flow rate at the heat pump 2 line, and/or
5) making the third temperature transmitter 18 reach a setpoint (constant or varying by means of optimizers, predictive models, etc.), and/or
6) making the fourth temperature transmitter 19 reach a setpoint (constant or varying by means of optimizers, predictive models, etc.).

In a preferred embodiment, similarly shown in FIG. 4, the first option is employed to allow the economizer 5 and heat pump 2 working between the same temperature levels, so to ensure a large water temperature difference across the air preheater 3, which is preferable with the current CO₂ heat pump technology employed in the shown embodiments.

Lastly, FIG. 6 depicts an alternative embodiment of a heating system 1, similar to the one shown in FIG. 1, but the second sink heater 4 is here not connected in series with the first sink heater 3. In this embodiment, the second sink heater 4 is placed on another stream, i.e. a second process medium, different to the one that flows into the first sink heater 3 and is configured to transfer heat to the second process medium. The process medium exiting the first sink heater enters into the dryer, while the exhaust medium exiting the second sink heater 4 flows into the heat exchanger 5. The heat exchanger 5 transfers heat from the exhaust medium of the second sink heater 5 to the secondary fluid used to provide heating to the process medium. The heat exchanger 5 is connected in parallel with the heat pump 2.

### LIST OF REFERENCE NUMERALS

1 Heat pump system
2 Heat pump
3 First sink heater/preheater
4 Second sink heater/process air heater
5 Heat exchanger/economizer
6 Control device/valve
7a Hot water pump
7b Cold water pump
8 Hot water pump skid
9 Cold water pump skid
10 Piping
11 Heat source
12 Drying plant
13 Electric heater
14 Controller
15 Temperature transmitter/sensor
16 First temperature transmitter/sensor
17 Second temperature transmitter/sensor
18 Third temperature transmitter/sensor
19 Fourth temperature transmitter/sensor
20 Spray drying apparatus
21 Drying chamber
22 Primary process gas inlet
23 Outlet of drying chamber
24 Fluidizer
25 Cyclone
26 Bag filter
27 Heat exchanger/preheater un dryer exhaust recovery system
28 Heat exchanger/dryer exhaust heat recovery unit
29 Piping

What is claimed is:

1. A heating system comprising a heat pump system,
the heat pump system comprising a heat pump, operating with a primary fluid, a secondary fluid and a first sink heater, the heat pump being connected to the first sink heater,
wherein the first sink heater is configured to preheat a first process medium,
the heating system further comprising a second sink heater,
wherein the second sink heater is configured to transfer heat to a second process medium,
the heat pump system further comprising a heat exchanger being connected to the second sink heater and being configured to transfer heat from an exhaust medium of the second sink heater to the secondary fluid used to provide heating to the first process medium,
wherein the heat pump is connected to the heat exchanger in a parallel configuration.

2. A heating system according to claim 1, wherein the primary fluid is an operating medium in a transcritical cycle, preferably comprising R744.

3. A heating system according to claim 1, wherein the first process medium is an air stream.

4. A heating system according to claim 1, wherein the heat exchanger is a plate, fin-and-tube, shell and tube, dimple plate, or tube in tube heat exchanger.

5. A heating system according to claim 1, wherein the heating system is configured to be installed in a drying plant.

6. A heating system according to claim 5, wherein the drying plant comprises a spray drying apparatus.

7. A heating system according to claim 1, wherein the second process medium is the same as the first process medium, the second sink heater is arranged after the first sink heater in the flow direction of the first process medium and the second sink heater generates the exhaust medium.

8. A heating system according to claim 7, wherein the heat exchanger is configured to recover only sensible or sensible and latent heat from the exhaust medium leaving the second sink heater.

9. A heating system according to claim 1, wherein the heat pump system further comprises a control device for controlling by one or more of flow, pressure, or temperature the connection of the heat exchanger with the first sink heater and the heat pump.

10. A heating system according to claim 1, wherein the heat exchanger comprises an inlet and an outlet, and the control device is a flow regulation device installed between the heat pump and the first sink heater, the heat pump system further comprising a first temperature sensor positioned at the outlet of the heat exchanger.

11. A heating system according to claim 10, wherein the control device is configured to operate such that a temperature of the first temperature sensor is in accordance with a predefined temperature setpoint.

12. A heating system according to claim 10, wherein the heat pump system further comprises a temperature transmitter connected with the first temperature sensor.

13. A heating system according to claim 10, wherein the heat pump comprises an inlet and an outlet, the heat pump system further comprising a second temperature sensor positioned at the outlet of the heat pump, wherein the control device is configured to operate such that a temperature of the first temperature sensor is in accordance with a temperature at the second temperature sensor.

14. A heating system according to claim 6, wherein the first sink heater constitutes a preheater for drying gas to the spray drying apparatus, wherein the second sink heater constitutes a process gas heater for drying gas to the spray drying apparatus, and wherein the heat exchanger constitutes an economizer having an inlet connected to the outlet of the process gas heater and an outlet configured to be connected to the inlet of the preheater.

15. A heating system according to claim 6, wherein the process medium constitutes a gaseous stream, wherein the secondary fluid constitutes water and wherein the primary fluid of the heat pump comprises carbon dioxide.

16. A heating system according to claim 6, wherein the heat pump system further comprises a circulation pump connected with the first sink heater and the heat pump.

17. A heating system according to claim 6, wherein the heat pump is further connected to one or multiple heat sources, the heat source being connected to the heat pump via an ice or cold water circuit.

18. A heating system according to claim 6, wherein the heat pump system comprises a fluid network and control devices, wherein the heat pump is connected to the fluid network, wherein the control devices can control the flow, flow direction, pressure and temperature of parts of the fluid network.

19. A method for integrating a heating system into a drying plant, the heating system comprising a heat pump system, the heat pump system comprising a heat pump operating with a primary fluid and a secondary fluid, a first sink heater and a heat exchanger, the method comprising:
connecting the heat pump with the first sink heater, wherein the first sink heater is configured to preheat a first process medium,
a second process medium entering a second sink heater,
the second sink heater being configured to transfer heat to the second process medium,
connecting the heat exchanger to the second sink heater such that the heat exchanger can transfer heat from an exhaust medium of the second sink heater to the secondary fluid used to provide heating to the first process medium,
connecting the heat pump to the heat exchanger in a parallel configuration, and
controlling by one or more of flow, pressure, or temperature the connection of the heat exchanger to the heat pump with a control device.

20. A method for integrating a heating system into a drying plant according to claim 19, wherein the drying plant comprises a spray drying apparatus and wherein the first sink heater constitutes a preheater for drying air to the spray drying apparatus, wherein the second sink heater constitutes a process air heater for drying air to the spray drying apparatus, and wherein the heat exchanger constitutes an economizer having an inlet connected to the outlet of the process air heater and an outlet configured to be connected to the inlet of the preheater.
